(19) United States
(12) Patent Application Publication
(10) Pub. No.: US 2025/0173886 A1
(43) Pub. Date: May 29, 2025

(54) Systems and Methods for Targetless Auto-calibration and Depth Estimation

(71) Applicant: Vayu Robotics, Inc., Palo Alto, CA (US)

(72) Inventors: Sudhansh Yelishetty, Palo Alto, CA (US); Mahesh Krishnamurthi, Saratoga, CA (US)

(73) Assignee: Vayu Robotics, Inc., Palo Alto, CA (US)

(21) Appl. No.: 18/961,198

(22) Filed: Nov. 26, 2024

Related U.S. Application Data
(60) Provisional application No. 63/603,445, filed on Nov. 28, 2023.

(51) Int. Cl. G06T 7/593; G06T 7/33; G06T 7/80; G06V 10/75

(52) U.S. Cl. CPC G06T 7/593; G06T 7/33; G06T 7/85; G06V 10/751; G06T 2207/10012

(57) ABSTRACT

Systems and methods for depth estimation in accordance with embodiments of the invention are illustrated. One embodiment includes a method for depth estimation. The method includes steps for identifying feature matches across several images, determining a set of homographies based on the identified feature matches, performing an uncalibrated rectification on a first image of the several images based on the set of determined homographies, and performing depth estimation based on at least the rectified image.

### CROSS-REFERENCE TO RELATED APPLICATIONS

The current application claims the benefit of and priority under 35 U.S.C. § 119 (e) to U.S. Provisional Patent Application No. 63/603,445 entitled “Systems and Methods for Targetless Auto-calibration and Depth Estimation” filed Nov. 28, 2023. The disclosure of U.S. Provisional Patent Application No. 63/603,445 is hereby incorporated by reference in its entirety for all purposes.

### FIELD OF THE INVENTION

The present invention generally relates to depth estimation and, more specifically, targetless auto-calibration and depth estimation.

### BACKGROUND

Stereo depth estimation is a technique used to determine the depth or 3D structure of a scene from a pair of stereo images. Common methods for stereo depth estimation often rely on calibrated cameras, as well as predefined targets or features in a scene. In many cases, such predefined targets can be defined based on images of a known scene (e.g., one containing a known structure, pattern, object, etc.). However, bumpy and jerky ego-motion (e.g., in robots) can throw off the extrinsics of a calibrated stereo camera system, and temperature changes can affect the intrinsics of each individual camera in the rig. It can also be difficult to reliably identify predefined targets or features in a scene.

### SUMMARY OF THE INVENTION

Systems and methods for depth estimation in accordance with embodiments of the invention are illustrated. One embodiment includes a method for depth estimation. The method includes steps for identifying feature matches across several images, determining a set of homographies based on the identified feature matches, performing an uncalibrated rectification on a first image of the several images based on the set of determined homographies, and performing depth estimation based on at least the rectified image.

In a further embodiment, identifying feature matches includes utilizing Local Feature Matching with Transformers.

In still another embodiment, identifying feature matches includes identifying sub-pixel accurate feature matches.

In a still further embodiment, identifying feature matches includes filtering a set of candidate feature matches to identify the feature matches.

In yet another embodiment, filtering the set of candidate feature matches is based on a confidence level associated with each candidate feature match.

In a yet further embodiment, the set of determined homographies includes at least one selected from the group consisting of a vertical alignment homography, a global distortion minimization homography, and a horizontal alignment homography.

In another additional embodiment, performing the uncalibrated rectification includes applying a combination of the vertical alignment homography, the global distortion minimization homography, and the horizontal alignment homography.

In a further additional embodiment, determining the set of homographies includes determining whether to utilize a horizontal alignment homography based on an angle change between the first image and a second image of the several images.

In another embodiment again, performing depth estimation includes generating a disparity map.

In a further embodiment again, performing depth estimation includes generating a depth map.

In still yet another embodiment, the method further includes steps for determining extrinsics of a set of cameras associated with the several images based on the identified feature matches.

In a still yet further embodiment, determining extrinsics includes computing epipolar constraints based on the identified feature matches.

In still another additional embodiment, determining extrinsics of the set of cameras is performed in parallel with determining the set of homographies and performing an uncalibrated rectification.

One embodiment includes a computer-readable medium including instructions which, when executed by a computer, cause the computer to carry out methods for depth estimation in accordance with various embodiments of the invention.

One embodiment includes a system including means for carrying out methods for depth estimation in accordance with various embodiments of the invention.

One embodiment includes a method for depth estimation. The method includes steps for identifying feature matches across several images, determining a vertical alignment homography based on the identified feature matches, performing a first transformation on at least one of the plurality of images based on the determined vertical alignment homography to generate a first transformed image, determining a global distortion minimization homography based on feature matches identified based on the first transformed image, performing a second transformation on the first transformed image based on the determined global distortion minimization homography to generate a second transformed image, determining a horizontal alignment homography based on feature matches identified based on the second transformed image, performing a third transformation on the second transformed based on the determined horizontal alignment homography to generate a rectified image, and performing depth estimation based on at least the rectified image.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 conceptually illustrates a process for depth estimation in accordance with an embodiment of the invention.

FIG. 2 illustrates an example of disparity information generated in accordance with many embodiments of the invention.

FIGS. 3A-C illustrate examples of the effects of a vertical alignment, global distortion minimization, and horizontal alignment in accordance with an embodiment of the invention.

FIG. 4 illustrates an example of a depth estimation system that estimates depth in accordance with an embodiment of the invention.

FIG. 5 illustrates an example of a depth estimation element that executes instructions to perform processes that estimate depth in accordance with an embodiment of the invention.

### DETAILED DESCRIPTION

Turning now to the drawings, systems and methods in accordance with numerous embodiments of the invention perform an uncalibrated rectification to be used for depth estimation. In various embodiments, processes can compute the extrinsics of a stereo rig simultaneously. Unlike classical (calibrated) rectification, processes in accordance with some embodiments of the invention do not need calibration parameters, and hence can adapt to changes in calibration and/or orientation. In several embodiments, processes avoid the need for predefined targets by utilizing image-level features which are present in the common field-of-view of both cameras.

### A. Processes for Depth Estimation

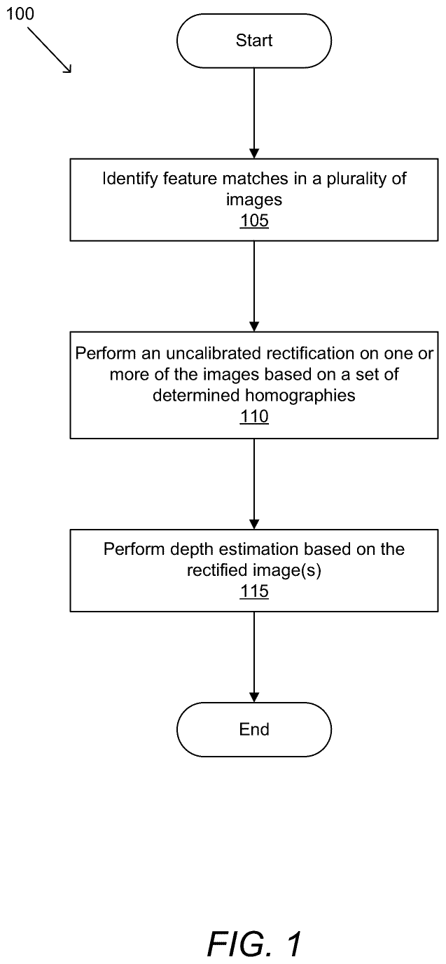

Processes for depth and/or disparity estimation in accordance with some embodiments of the invention can be performed on stereo images, multiview stereo images, and/or images captured from multiple perspectives on a single camera, etc. Disparity is a measure of the difference in horizontal position between corresponding points in the left and right images of a stereo pair. Depth in accordance with a variety of embodiments of the invention can be inferred from disparity. Although many of the examples described herein refer to depth or disparity, one skilled in the art will recognize that similar systems and methods can be used for disparity, depth, and/or various other related applications without departing from this invention. In various embodiments, depth estimation can be performed for robots operating in various environments, where the alignment for the cameras may be unreliable. A process for depth estimation in accordance with an embodiment of the invention is illustrated in FIG. 1.

Process 100 identifies (105) feature matches in a plurality of images. Feature matching in accordance with several embodiments of the invention can be performed using one or more of a variety of feature matching processes, such as (but not limited to) Local Feature Matching with Transformers (LoFTR). Processes in accordance with numerous embodiments of the invention identify feature matches between images to produce sub-pixel accurate feature matches in the pair. In many embodiments, processes filter candidate feature matches based on a threshold (e.g., a 90%+ confidence level). Identified feature matches in accordance with numerous embodiments of the invention are used for rectification and/or extrinsics determination.

Process 100 can perform (110) an uncalibrated rectification on one or more of the images based on a set of determined homographies. Homographies in accordance with some embodiments of the invention include mathematical transformations (e.g., rotations, translations, perspective changes, etc.) that relate coordinates of points in one plane (or image) to coordinates of corresponding points in another plane (e.g., of a second image). Homographies can be used to describe geometric relationships between images. Homographies in accordance with many embodiments of the invention are determined based on identified feature matches.

In many embodiments, rectification may only be performed on one (e.g., the right image) of a pair of stereo images. Processes in accordance with certain embodiments of the invention can perform uncalibrated rectification in multiple stages. Stages for uncalibrated rectification in accordance with a variety of embodiments of the invention can include (but are not limited to) vertical alignment, global distortion minimization, and/or horizontal alignment. Examples of rectification in accordance with a number of embodiments of the invention are described in greater detail below.

Process 100 performs (115) depth estimation based on the rectified images. Performing depth estimate in accordance with certain embodiments of the invention can include generating a disparity map between pairs of images. Depth estimation in accordance with certain embodiments of the invention can include (but is not limited to) generating disparity information, generating disparity maps, generating depth maps, etc. In a number of embodiments, depth estimation can be performed using various depth/disparity estimation networks, such as (but not limited to) CREStereo.

In addition to performing depth estimation based on the identified feature matches, processes in accordance with several embodiments of the invention determine the relative orientations (or extrinsics) of the camera(s) when the images were captured. Determining relative orientations in accordance with numerous embodiments of the invention can be performed in parallel with the depth estimations. In various embodiments, determining the extrinsics of the camera(s) can be performed by computing epipolar constraints based on identified feature matches.

While specific processes for depth estimation are described above, any of a variety of processes can be utilized to estimate depth as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

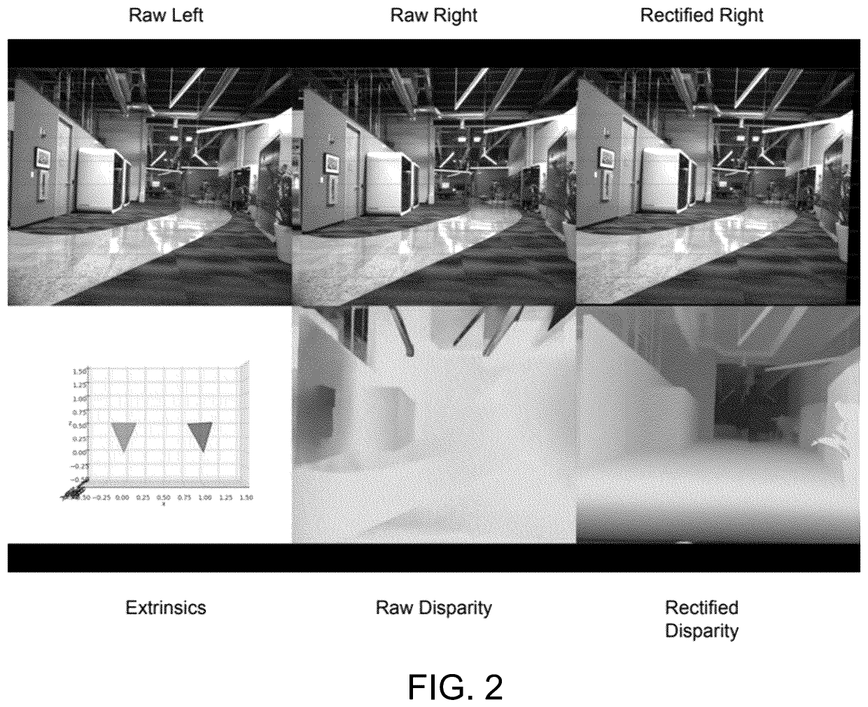

An example of disparity information estimated in accordance with many embodiments of the invention is illustrated in FIG. 2. In this example, stereo images (Raw Left and Raw Right) are shown, along with a disparity map (Raw Disparity) generated based on the raw images. This example further illustrates the rectified image (Rectified Right) and the associated rectified disparity map, which contains significantly more detailed and accurate depth estimations.

### B. Rectification

In several embodiments, for a pair of stereo images, only the right image is warped, while the left image remains the same (or is warped with identity). In numerous embodiments, rectification can be performed with a combination of three (3) homographies: vertical alignment (Hy), global distortion minimization (Hs), and horizontal shift (Hk). The overall homography in accordance with some embodiments of the invention is,

Hₗ=I,Hᵣ=HₖHₛH_{y}

### 1. Vertical Alignment

Vertical alignment in accordance with a number of embodiments of the invention allows for perfectly horizontal and in-line epipolar lines. Processes in accordance with certain embodiments of the invention can use various methods for vertical alignment, such as but not limited to Hartley's algorithm, OpenCV's stereo RectifyUncalibrated ( ) function, etc.

$${H}_{1} , {H}_{2} = stereoRectifyUncalibrated ( {matched}_{features} )$$

$${H}_{y} = {H}_{1}^{- 1} {H}_{2}$$

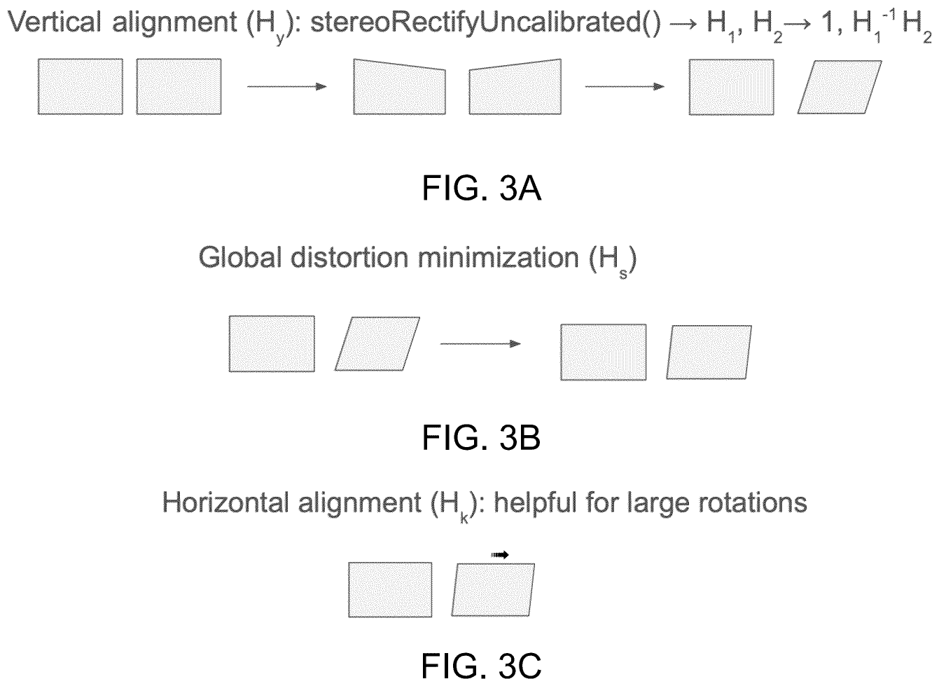

An example of the effects of a vertical alignment are illustrated in FIG. 3A. In this example, the first two images are the inputs to the vertical alignment process. The middle two images are a representation of what happens at the end of other off-the-shelf vertical alignment processes. The last two images represent the results of vertical alignment in accordance with some embodiments of the invention.

### 2. Global Distortion Minimization

Global distortion minimization homographies in accordance with a variety of embodiments of the invention are shearing matrices of the type

$${H}_{s} = [ \begin{matrix}{s}_{a} & {s}_{b} & 0 \\ 0 & 1 & 0 \\ 0 & 0 & 1\end{matrix} ]$$

Such shearing matrices may only affect the x-coordinate of a point.

Let the center of the edges of the image be a, b, c, and d, starting from the top of the image in a clockwise manner. Global distortion homographies remap these coordinates using H_{y} to get â, \hat{b}, ĉ, and \hat{d}. Let u=\hat{b}−â=[uₓ u_{y} 0]^{T} and v=â−ĉ=[vₓ v_{y} 0]^{T}.

Parameters sₐ and s_{b} can be used to maintain perpendicularity and aspect ratio between the vertical and horizontal vectors above. Solving for these can be a closed-form solution. An example of the effects of a global distortion minimization are illustrated in FIG. 3B.

### 3. Horizontal Alignment

As various stages of warping are performed on an image, it may result in black (or empty) space around the image. Horizontal alignment in accordance with some embodiments of the invention can be performed to reduce the black spaces after warping. In a number of embodiments, processes run a loop to find the smallest k that satisfies a given condition (e.g., threshold amount of black space). Processes in accordance with a variety of embodiments of the invention may utilize a maximal condition to ensure negative disparities. In various embodiments, processes may determine whether to apply a horizontal alignment based on an angle change between stereo images (e.g., horizontal alignments may be applied for large angle changes (e.g., up to 30-35 degrees), while not for smaller angle changes (e.g., 5-10 degrees). One skilled in the art will recognize that similar systems and methods can use various thresholds and conditions without departing from this invention. An example of the effects of a horizontal alignment are illustrated in FIG. 3C.

### C. Systems for Estimating Depth

### 4. Depth Estimation Systems

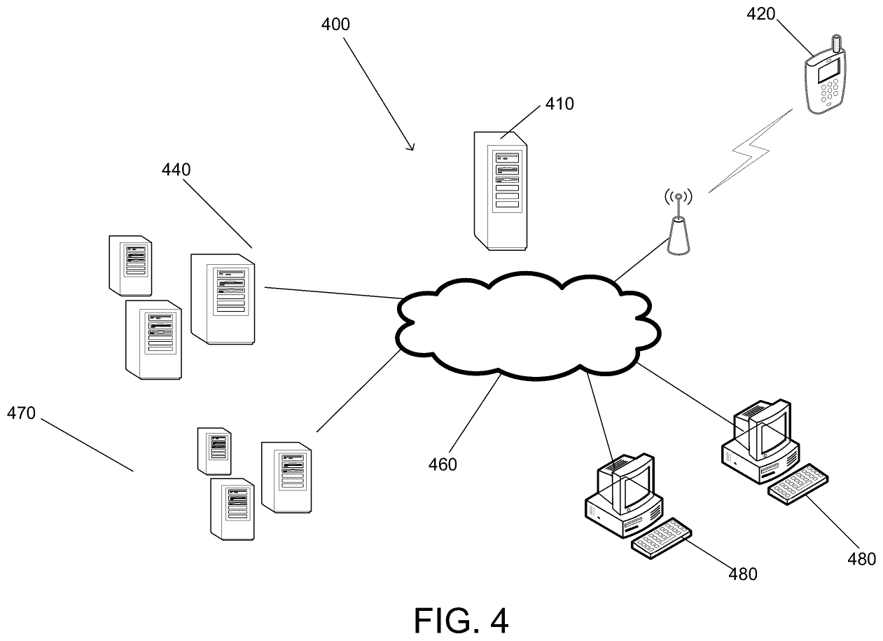

An example of a depth estimation system that estimates depth in accordance with an embodiment of the invention is illustrated in FIG. 4. Network 400 includes a communications network 460. The communications network 460 is a network such as the Internet that allows devices connected to the network 460 to communicate with other connected devices. Server systems 410, 440, and 470 are connected to the network 460. Each of the server systems 410, 440, and 470 is a group of one or more servers communicatively connected to one another via internal networks that execute processes that provide cloud services to users over the network 460. One skilled in the art will recognize that a depth estimation system may exclude certain components and/or include other components that are omitted for brevity without departing from this invention.

For purposes of this discussion, cloud services are one or more applications that are executed by one or more server systems to provide data and/or executable applications to devices over a network. The server systems 410, 440, and 470 are shown each having three servers in the internal network. However, the server systems 410, 440 and 470 may include any number of servers and any additional number of server systems may be connected to the network 460 to provide cloud services. In accordance with various embodiments of this invention, a depth estimation system that uses systems and methods that estimate depth in accordance with an embodiment of the invention may be provided by a process being executed on a single server system and/or a group of server systems communicating over network 460.

Users may use personal devices 480 and 420 that connect to the network 460 to perform processes that estimate depth in accordance with various embodiments of the invention. In the shown embodiment, the personal devices 480 are shown as desktop computers that are connected via a conventional “wired” connection to the network 460. However, the personal device 480 may be a desktop computer, a laptop computer, a smart television, an entertainment gaming console, or any other device that connects to the network 460 via a “wired” connection. The mobile device 420 connects to network 460 using a wireless connection. A wireless connection is a connection that uses Radio Frequency (RF) signals, Infrared signals, or any other form of wireless signaling to connect to the network 460. In the example of this figure, the mobile device 420 is a mobile telephone. However, mobile device 420 may be a mobile phone, Personal Digital Assistant (PDA), a tablet, a smartphone, or any other type of device that connects to network 460 via wireless connection without departing from this invention.

As can readily be appreciated, the specific computing system used to estimate depth is largely dependent upon the requirements of a given application and should not be considered as limited to any specific computing system(s) implementation.

### 5. Depth Estimation Element

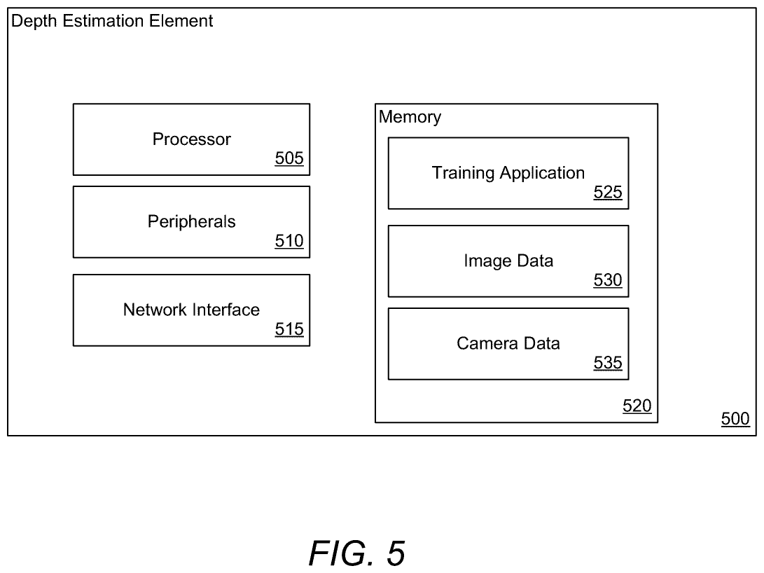

An example of a depth estimation element that executes instructions to perform processes that estimate depth in accordance with an embodiment of the invention is illustrated in FIG. 5. Depth estimation elements in accordance with many embodiments of the invention can include (but are not limited to) one or more of mobile devices, cameras, and/or computers. Depth estimation element 500 includes processor 505, peripherals 510, network interface 515, and memory 520. One skilled in the art will recognize that a depth estimation element may exclude certain components and/or include other components that are omitted for brevity without departing from this invention.

The processor 505 can include (but is not limited to) a processor, microprocessor, controller, or a combination of processors, microprocessor, and/or controllers that performs instructions stored in the memory 520 to manipulate data stored in the memory. Processor instructions can configure the processor 505 to perform processes in accordance with various embodiments of the invention. In various embodiments, processor instructions can be stored on a non-transitory machine readable medium.

Peripherals 510 can include any of a variety of components for capturing data, such as (but not limited to) cameras, displays, and/or sensors. In a variety of embodiments, peripherals can be used to gather inputs and/or provide outputs. Depth estimation element 500 can utilize network interface 515 to transmit and receive data over a network based upon the instructions performed by processor 505. Peripherals and/or network interfaces in accordance with many embodiments of the invention can be used to gather inputs that can be used to estimate depth.

Memory 520 includes a depth estimation application 525, image data 530, and camera data 535. Depth estimation applications in accordance with several embodiments of the invention can be used to estimate depth.

Image data in accordance with a number of embodiments of the invention includes images captured from one or more cameras in a depth estimation system. In certain embodiments, image data can include data captured from multiple perspectives at a single point in time. Alternatively, or conjunctively, image data in accordance with certain embodiments of the invention can include data captured from one or more cameras at multiple points in time.

In numerous embodiments, camera data can include various types of data associated with camera(s) in a depth estimation system. Camera data in accordance with several embodiments of the invention can include (but is not limited to) calibration data, extrinsic data, intrinsic data, camera make/model, etc. In various embodiments, camera data can be used to update and/or modify depth estimation data. Alternatively, or conjunctively, depth estimation data in accordance with a number of embodiments of the invention can be used to update camera data (e.g., to adjust camera calibrations).

Although a specific example of a depth estimation element 500 is illustrated in this figure, any of a variety of depth estimation elements can be utilized to perform processes for depth estimation similar to those described herein as appropriate to the requirements of specific applications in accordance with embodiments of the invention.

Although specific methods of depth estimation are discussed above, many different methods of depth estimation can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for depth estimation, the method comprising:
identifying feature matches across a plurality of images;
determining a set of homographies based on the identified feature matches;
performing an uncalibrated rectification on a first image of the plurality of images based on the set of determined homographies; and
performing depth estimation based on at least the rectified image.

2. The method of claim 1, wherein identifying feature matches comprises utilizing Local Feature Matching with Transformers.

3. The method of claim 1, wherein identifying feature matches comprises identifying sub-pixel accurate feature matches.

4. The method of claim 1, wherein identifying feature matches comprises filtering a set of candidate feature matches to identify the feature matches.

5. The method of claim 4, wherein filtering the set of candidate feature matches is based on a confidence level associated with each candidate feature match.

6. The method of claim 1, wherein the set of determined homographies comprises at least one selected from the group consisting of a vertical alignment homography, a global distortion minimization homography, and a horizontal alignment homography.

7. The method of claim 6, wherein performing the uncalibrated rectification comprises applying a combination of the vertical alignment homography, the global distortion minimization homography, and the horizontal alignment homography.

8. The method of claim 6, wherein determining the set of homographies comprises determining whether to utilize a horizontal alignment homography based on an angle change between the first image and a second image of the plurality of images.

9. The method of claim 1, wherein performing depth estimation comprises generating a disparity map.

10. The method of claim 1, wherein performing depth estimation comprises generating a depth map.

11. The method of claim 1 further comprising determining extrinsics of a set of cameras associated with the plurality of images based on the identified feature matches.

12. The method of claim 11, wherein determining extrinsics comprises computing epipolar constraints based on the identified feature matches.

13. The method of claim 11, wherein determining extrinsics of the set of cameras is performed in parallel with determining the set of homographies and performing an uncalibrated rectification.

14. A system comprising:
a set of one or more processors; and
a non-transitory machine readable medium containing program instructions that are executable by the set of processors to perform a method comprising:
identifying feature matches across a plurality of images;
determining a set of homographies based on the identified feature matches;
performing an uncalibrated rectification on a first image of the plurality of images based on the set of determined homographies; and
performing depth estimation based on at least the rectified image.

15. The system of claim 14, wherein identifying feature matches comprises identifying sub-pixel accurate feature matches.

16. The system of claim 14, wherein identifying feature matches comprises filtering a set of candidate feature matches to identify the feature matches based on a confidence level associated with each candidate feature match.

17. The system of claim 14, wherein:
the set of determined homographies comprises a vertical alignment homography, a global distortion minimization homography, and a horizontal alignment homography; and
performing the uncalibrated rectification comprises applying a combination of the vertical alignment homography, the global distortion minimization homography, and the horizontal alignment homography.

18. The system of claim 14, wherein determining the set of homographies comprises determining whether to utilize a horizontal alignment homography based on an angle change between the first image and a second image of the plurality of images.

19. The system of claim 14 further comprising determining extrinsics of a set of cameras associated with the plurality of images based on the identified feature matches, wherein:
determining extrinsics comprises computing epipolar constraints based on the identified feature matches; and
determining extrinsics of the set of cameras is performed in parallel with determining the set of homographies and performing an uncalibrated rectification.

20. A method for depth estimation, the method comprising:
identifying feature matches across a plurality of images;
determining a vertical alignment homography based on the identified feature matches;
performing a first transformation on at least one of the plurality of images based on the determined vertical alignment homography to generate a first transformed image;
determining a global distortion minimization homography based on feature matches identified based on the first transformed image;
performing a second transformation on the first transformed image based on the determined global distortion minimization homography to generate a second transformed image;
determining a horizontal alignment homography based on feature matches identified based on the second transformed image;
performing a third transformation on the second transformed based on the determined horizontal alignment homography to generate a rectified image; and
performing depth estimation based on at least the rectified image.
